(19) United States
(12) Patent Application Publication
(10) Pub. No.: US 2005/0154887 A1
(43) Pub. Date: Jul. 14, 2005

(54) System and method for secure network state management and single sign-on

(75) Inventors: Peter Daniel Birk, Austin, TX (US); Ching-Yun Chao, Austin, TX (US); Hyen Vui Chung, Round Rock, TX (US); Carlton Keith Mason, Austin, TX (US); Karkala Ajay Reddy, Austin, TX (US); Vishwanath Venkataramappa, Austin, TX (US); Dennis Wayne Riddlemoser, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/755,835

(22) Filed: Jan. 12, 2004

(51) Int. Cl. G06F 11/30; H04L 9/00

(52) U.S. Cl. 713/168; 713/201; 713/150

(57) ABSTRACT

State management (cookie) data is encrypted so that access control data included in the cookie is unable to be modified by the user. A hashing algorithm is performed using various fields in the cookie data and the hash value is encrypted. The hash value is combined with other data such as the user identifier and a time stamp and encrypted to form a cookie value. When a request is received, the cookie data is checked. If the token value is not in the server's cache then the token is authenticated facilitating movement of the client between servers. If the cookie does not exist or is timed out, then the user is authenticated using traditional means.

### BACKGROUND OF THE INVENTION

1. Technical Field

The present invention relates in general to a method and system for protecting client state information. More particularly, the present invention relates to a system and method for preventing state (i.e., “cookie”) data from tampering in providing a single sign-on to computer systems.

2. Description of the Related Art

HyperText Transfer Protocol (HTTP), is the underlying protocol used by the World Wide Web. HTTP defines how messages are formatted and transmitted, and what actions Web servers and browsers take in response to various commands. For example, when a user enters a URL (Uniform Resource Locator—the global address of documents and other resources on the World Wide Web) in a browser, an HTTP command is sent to the Web server directing it to fetch and transmit the requested Web page. The current HTTP protocol is “stateless,” meaning that the server does not store any information about a particular HTTP transaction; each connection between a client and a server is “fresh” and has no knowledge of any previous HTTP transactions. “State” information is information about a communication between a client and a server. In some cases it is useful to maintain state information about the user across multiple HTTP transactions.

When returning an HTTP object or other network information to a client, a server may include a piece of state information which is stored by the client. Included in that state object is a description of the range of URLs for which that state is valid. Any future requests made by the client which fall in that URL range will include a transmittal of the current value of the state object from the client back to the server. As described above, the state object is often called a “cookie,” for no compelling reason.

Some Internet Web sites (i.e., servers) store client state information in a small text file, sometimes called a “cookie,” on the client's (i.e., user's) hard drive or in memory located on the client computer. Internet Browsers, such as Microsoft's Internet Explorer™ and Netscape's Navigator™, are often set up to allow the creation of these state objects. The user, however, can specify that a prompt be provided before a Web site puts a state object on the user's hard disk or memory. In this manner, the user can choose to accept or reject state objects. The user can also configure the browser to prevent the acceptance of any state objects.

State objects contain information about the user and his or her preferences. For example, if the user inquires about a flight schedule at an airline's Web site, the site might create a state object (i.e., a cookie) that contains the user's itinerary. Or it might only contain a record of which pages within the site the user visited, in order to help the site customize the view for the user during subsequent visits to the Web site.

State objects are small data structures used by a Web site to deliver data to a Web client and store the data on the client's hard drive or memory. In certain circumstances, the client returns the information to the Web site. Web sites can thus “remember” information about users to facilitate their preferences for a particular site. The Web site may deliver one or more state objects to the client which are stored as flat files on the client's local hard drive or memory. In a security application, cookies can store authentication information indicating the applications, servers, or other privileges that the user is authorized to use on the server (or a group of servers). A challenge, however of storing security credentials in a typical cookie is that the user of the client computer is able to change the security credentials and “spoof” the server causing the user to have greater authorizations than intended.

Only the information provided by the user or choices made by the user while visiting a Web site can be stored in a state object. For example, the Web site cannot determine the user's e-mail name unless the user provides it. Allowing a Web site to create a state object, or cookie, on the client's computer does not give the Web site, or any other Web site, access to the rest of the client computer. In addition, only the Web site that created the state object is able to read it.

State objects are a general mechanism which server side connections (i.e., Web sites) can use to both store and retrieve information on the client (i.e., user) side of the connection. The addition of a simple, persistent, client-side state significantly extends the capabilities of Web-based client/server applications. Web sites use state objects to simulate a continuous connection to the Web site. This makes it more convenient for users by allowing them to visit pages within a site without having to reintroduce themselves with each mouse click. In a security application, cookies may allow the user to access various applications without the need to re-authenticate the user, as the user's authorizations can be stored in a cookie during the initial authentication.

As can be readily seen, cookies provide powerful tool that enables a host of applications to be written for Web-based environments. Shopping applications can store information about currently selected items, for fee services can send back registration information and free the client from retyping a user-id on subsequent connections, and Web sites can store per-user preferences on the client computer. These preferences can be automatically supplied by the client computer when the client subsequently connects to the server.

A cookie is introduced to the client by including a “Set-Cookie” header as part of an HTTP response; often this will be generated by a CGI script. CGI stands for “Common Gateway Interface,” a specification for transferring information between a World Wide Web server and a CGI program. A CGI program is any program designed to accept and return data that conforms to the CGI specification. The program could be written in any programming language, including C, Perl, Java, or Visual Basic.

Syntax of the Set-Cookie HTTP Response Header

This is the format a CGI script would use to add to the HTTP headers a new piece of data which is to be stored by the client for later retrieval:

Set-Cookie: NAME=VALUE; expires=DATE;

path=PATH; domain=DOMAIN_NAME; secure

Multiple Set-Cookie headers can be issued in a single server response.

NAME=VALUE

This string is a sequence of characters excluding semi-colon, comma and white space. This is the only required attribute on the Set-Cookie header.

Secure

If a cookie is marked secure, it will only be transmitted if the communications channel with the host is a secure one. Currently this means that secure cookies will only be sent to HTTPS (HTTP over SSL) servers. If secure is not specified, a cookie is considered safe to be sent in the clear over unsecured channels.

Syntax of the Cookie HTTP Request Header

When requesting a URL from an HTTP server, the browser will match the URL against all cookies and if any of them match, a line containing the name/value pairs of all matching cookies will be included in the HTTP request. Here is the format of that line:
Cookie: NAME1=OPAQUE_STRING1; NAME2=OPAQUE_STRING2

If a CGI script wishes to delete a cookie, it can do so by returning a cookie with the same name, and an expires time which is in the past. The path and name should match exactly in order for the expiring cookie to replace the valid cookie. This requirement makes it difficult for anyone but the originator of a cookie to delete a cookie.

When caching HTTP, as a proxy server might do, the Set-cookie response header should not be cached. If a proxy server receives a response which contains a Set-cookie header, it should propagate the Set-cookie header to the client, regardless of whether the response was 304 (Not Modified) or 200 (OK). Similarly, if a client request contains a Cookie: header, it should be forwarded through a proxy, even if the conditional If-modified-since request is being made.

A client computer has no way of determining whether a server actually needs a state object, such as a cookie. The browser, therefore, sends state object information to the server so long as the domain and path information matches. Because the current HTTP protocol is stateless, the state object is included in all requests to the server regardless of whether the server needs the information.

When a client requests a file from a server, it contacts the server using an address of the file on the server. The address the client enters includes (1) the protocol to use (i.e., HTTP), (2) the server name (e.g., “acme.com”), and (3) the file name (or resource name) of the file being requested (e.g., “main.htm”) . The browser communicates with a name server to translate the server name (e.g., www.acme.com) into an IP Address, which it uses to connect to that server machine. The browser then forms a connection to the Web server at that IP address on port 80. Following the HTTP protocol, the browser sends a GET request to the server, asking for the file “http://www.acme.com/main.htm”. At this point, any matching state information stored on the client (i.e. cookies) are sent to the server. The server then sends the file (i.e. the HTML text corresponding to main.htm) back to the browser. The server may also include state information in its response that is stored on the client. In the case of an HTML file, the browser reads the HTML tags and formats the page on the client's screen. One challenge with traditional use of cookies is that the server has little ability to detect whether a malicious user has modified the contents of the cookie in an attempt to spoof the server into granting the user greater authorizations or privileges than the user is otherwise allowed.

Server use the state information contained in cookies in many ways. The contents may be sensitive, such as the resources that the user is allowed to use. For example, a first server may perform a sign-on function for the user and, upon verifying the user's identity using sign-on information such as a user identifier and a password, may store the functions that the user is allowed to perform in a cookie. A malicious user, however, can modify the cookie contents to “spoof” the server. Subsequent reads of the modified cookie information would allow the malicious user greater access than originally authorized. While the user may only be allowed access to “general” functions, a malicious user can add data to the cookie to, for example, give the user access to “payroll” and “management” functions.

The secure flag, discussed previously, provides some protection by only transmitting cookie data over a secure path (such as an SSL transmission). Other cookie attributes, such as “Discard” and “Max-Age” can somewhat reduce the possibility of cookies being used in unauthorized or unintended ways. However, none of the forgoing methods prevents cookies from being modified by malicious users.

What is needed, therefore, is a way to protect cookie data from being modified by users. What is further needed, is a system and method that detects when a cookie has been modified by a user and performs security functions in response of such a detection.

### SUMMARY

It has been discovered that state management (cookie) data can be encrypted so that access control data included in the cookie is unable to be modified by the user. If the user can modify the cookie value and the access control data, a user may either impersonate another user or gain extra privileges. Two methods are used to resolve this problem. The first method is to create a hash value of the access control data including the cookie parameters, digital sign the hash value, and then encrypt the data. The second method is to save the sensitive access control data on the server side and not in the cookie. A mapping mechanism is used to map the cookie to the access control data on the server side. The cookie data may still contain security information that is used to make initial access control decision to improve performance. Hence the first method is helpful even when the second method may be used at the same time.

A hashing algorithm is performed using various fields in the cookie data. In one embodiment, these fields include the domain, Max-Age, path, and port fields. The hash value is encrypted. In one embodiment, the hash value is digitally signed. Using a Public Key-Private Key combination, the digital signature can be performed by encrypting the hash value with the server's private key so that the signature is authenticated by decrypting the hash value with the server's public key. The cookie value is created by combining the hash value with other data such as the user identifier and a time stamp. The cookie value is then encrypted so that a malicious user cannot determine the contents of the cookie value.

When a client computer system requests an application or other resource from the server, the cookie data is checked. If the client does not have an authentication cookie (i.e., the client's first access of the Web site), then the client is authenticated using traditional means (i.e., user identifier/password, digital certificate, biometric data, etc.). When the user's has been authenticated, the token (the value stored in the cookie) is stored in the server's access control cache so that the value in the cache can simply be compared with the value in the cookie data. If processing of the user's requests moves from one server to another server in a server group (i.e., a domain), then the second server authenticates the token and, upon authentication, stores the token in the second server's access control cache. In this manner, the user can access multiple servers without having to be authenticated (i.e., enter the user identifier/password) at each server.

The cookie contains a Single Sign-on token (SSO token). After a user is authenticated, the server uses an authentication token which can be used to uniquely identity the authenticated user. The server uses a mapping function to map an SSO token to an authentication token, or more precisely, to the user's security context. When the cookie, or the SSO token within the cookie, is sent to a different server in the domain which does not have the client context, there exists a mechanism that the second server can retrieve the user's security context from the first server and establish the mapping. The SSO token, besides carrying the information to prevent tempering, can also carry authenticating server information for the second server to request the authenticated user's security context information.

Regarding to the mapping mechanism, the SSO token is used as a key to look up the authenticated user's security context in the access control cache. The authentication token is part of the security context. The authentication token can be passed to other server which can be used to uniquely identify the authenticated user.

In one embodiment, the SSO token is different from the authentication token which can improve security. The SSO token can carry a random and unique session ID, while the authentication token typically contains a unique identifier of an authenticated user. The mapping from SSO token (random session ID) to authentication token (user identity) makes SSO token and cookie tampering more difficult.

This invention allows information to be securely saved in the cookie such that the receiving server performs initial access control and authenticates requests based on the information in the cookie. If the security context is not in the access control cache, the receiving server accesses the authenticating server to retrieve the security context information of the authenticated user only when the information in the SSO token passes the initial access control checking, e.g., domain name is correct, security realm name is correct, application name is correct, etc.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a network diagram showing the interaction between a client and a server group;

FIG. 2 is a flowchart and cookie file showing steps taken in creating an access cookie;

FIG. 3 is a flowchart showing steps taken by a server in processing a client's request;

FIG. 4 is a flowchart showing steps taken by a server in authenticating a client to a server;

FIG. 5 is a flowchart showing steps taken by a server in authenticating a token that has not been cached; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

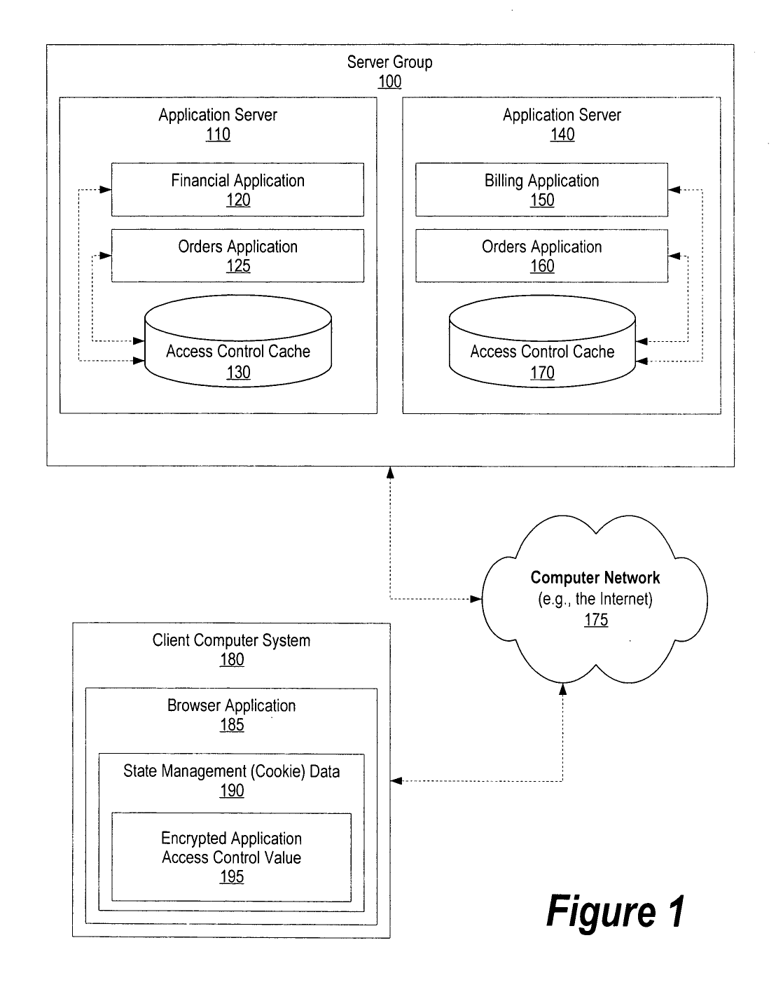

FIG. 1 is a network diagram showing the interaction between a client and a server group. Server group 100 is a protected Web site (i.e., URL) that uses state management (i.e., cookie) data stored 190 stored on client computer system 180 to determine the access permissions granted to the user.

When the user of client computer system 180 uses the accesses server group 100 through computer network 175, such as the Internet, the user is authenticated (i.e., by entering a user identifier and password) and the user's security attributes (i.e., which applications, servers, etc. the user is allowed to use) is stored in state management (cookie) data 190. In one embodiment, cookie data 190 is managed by Internet browser application 185, such as Microsoft's Internet Explorer™ product and Netscape's Navigator™ product. In addition, encrypted application access control value 195 is stored in state management data 190.

In the example shown, server group 100 includes two application servers: application server 110 and application server 140. Both of these servers include an order application (order application 125 and 160, respectively). In addition, application server 110 includes financial application 120, while application server 140 includes billing application 150. After being authenticated, state management (cookie) data 190 (stored on client computer system 180) indicates which applications the user is allowed to access. When the user visits server 110 or server 140 (within the same security domain 100), the user will not be challenged for a user identifier and authentication data so long as the user's security credentials stored in state management (cookie) data 190 are validated.

Each server includes an access control cache (cache 130 corresponding to server 110 and cache 170 corresponding to server 140). When a user has been authenticated at a particular server, a copy of the application access control value 195 is stored in the server's cache. For subsequent accesses by the user, the server simply uses the encrypted application access control value stored in the server's cache that is referenced by the value stored in the client's state management (cookie) data 190. The encrypted access control value (referred to as the “Single Sign-on token” or “SSO token”) is stored in the client's state management (cookie) data. In general, the SSO token is used as a key to retrieve the authenticated user's security context information. Not all the security context information is saved in the SSO token.

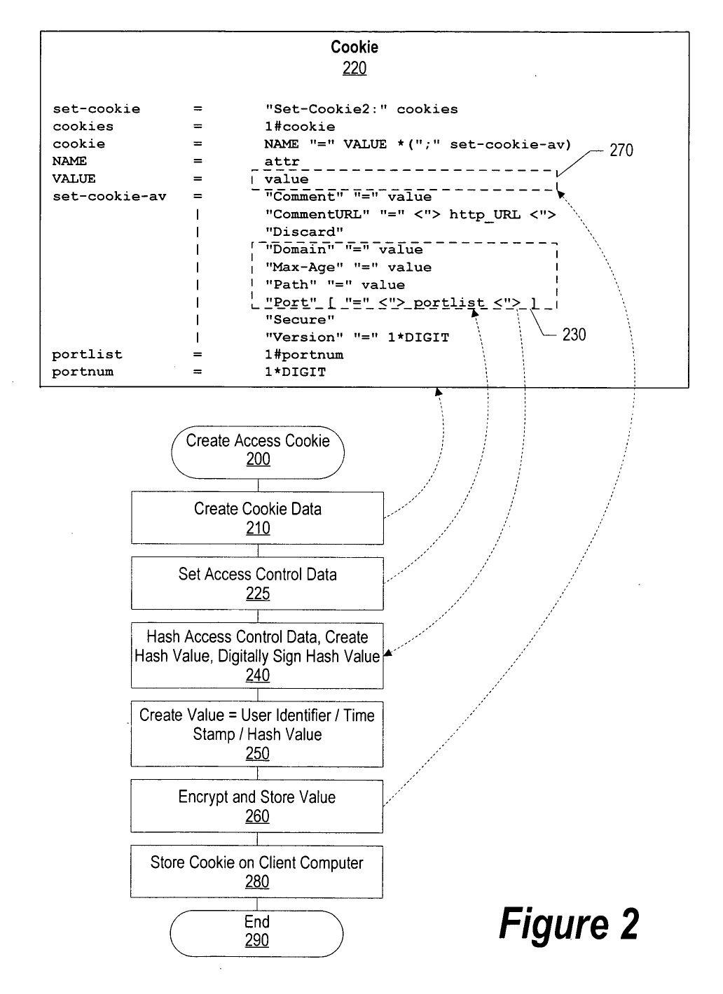

FIG. 2 is a flowchart and cookie file showing steps taken in creating an access cookie. Processing commences at 200 whereupon, at step 210, cookie 220 is created. At step 225, access control data 230 within the cookie is established. The access control data includes the domain name of the Web site, a “Max-Age” value, a “path” value, and a list of ports.

domain=DOMAIN NAME

When searching the cookie list for valid cookies, a comparison of the domain attributes of the cookie is made with the Internet domain name of the host from which the URL will be fetched. If there is a tail match, then the cookie will go through “path matching” to see if it should be sent (see description of “path,” below). “Tail matching” means that the domain attribute is matched against the tail of the fully qualified domain name of the host. A domain attribute of “acme.com” would therefore match host names “anvil.acme.com” as well as “shipping.crate.acme.com”. The default value of domain is the host name of the server which generated the cookie response.

Only hosts within the specified domain can set a cookie for a domain. Domains that store cookies have at least two (2) or three (3) periods in them to prevent domains of the form “.com”, “.edu”, and “va.us” from storing overly-broad cookies. Any domain that falls within one of the special top level domains (e.g., “.COM”, “.EDU”, “.NET”, “.ORG”, “.GOV”, “.MIL”, and “.INT”) requires at least two periods. Any other domain requires at least three periods.

Max-Age=DATE/TIME

The Max-Age attribute specifies a date/time string that defines the valid life time of the cookie. Once the expiration date has been reached, the cookie will no longer be stored or given out.

path=PATH

The path attribute is used to specify the subset of URLs in a domain for which the cookie is valid. If a cookie has already passed domain matching, then path matching takes place wherein the path name component of the URL is compared with the path attribute. If there is a prefix match, the cookie is considered valid and is sent along with the URL request. The path “/foo” would match “/foobar” and “/foo/bar.html”. The path “/” is the most general path and matches any path within the domain.

If the path is not specified, it as assumed to be the same path as the document being described by the header which contains the cookie. Setting the path to a higher-level value does not override other more specific path mappings. If there are multiple matches for a given cookie name, but with separate paths, all the matching cookies will be sent. Instances of the same path and name will overwrite each other, with the latest instance taking precedence. Instances of the same path but different names will add additional mappings. When sending cookies to a server, all cookies with a more specific path mapping should be sent before cookies with less specific path mappings. For example, a cookie “namel=foo” with a path mapping of “/” should be sent after a cookie “name1=foo2” with a path mapping of “/bar” if they are both to be sent.

port=Portlist

The port attribute is used to specify one or more ports. This optional parameter is to help the browser determine whether a set cookie request from the server should be rejected. The Port attribute restricts the port to which a cookie may be returned in a Cookie request header. For example, a Set-Cookie2 with Port=“80,8000” will be accepted if the request was made to port 80 or 8000 and will be rejected otherwise.

At step 240, the server hashes the access control data, thus creating a hash value. In addition, the server digitally signs the hash value.

At step 250, the server creates the value of the cookie based upon the user's (i.e., client's) identifier, a timestamp, and the hash value created in step 240.

At step 260, the value is encrypted and stored as value 270 within cookie data structure 220. As the client does not know the encryption keys to digitally sign the hash value in step 240 or to encrypt the value in step 260, it is exceedingly difficult for the user to successfully hack cookie 220 and spoof the server.

At step 280, the cookie, complete with the encrypted value 270 that includes a hash of access control data 230, is stored on the client computer system for subsequent retrieval by the Web site. Create access cookie processing thereafter ends at 290.

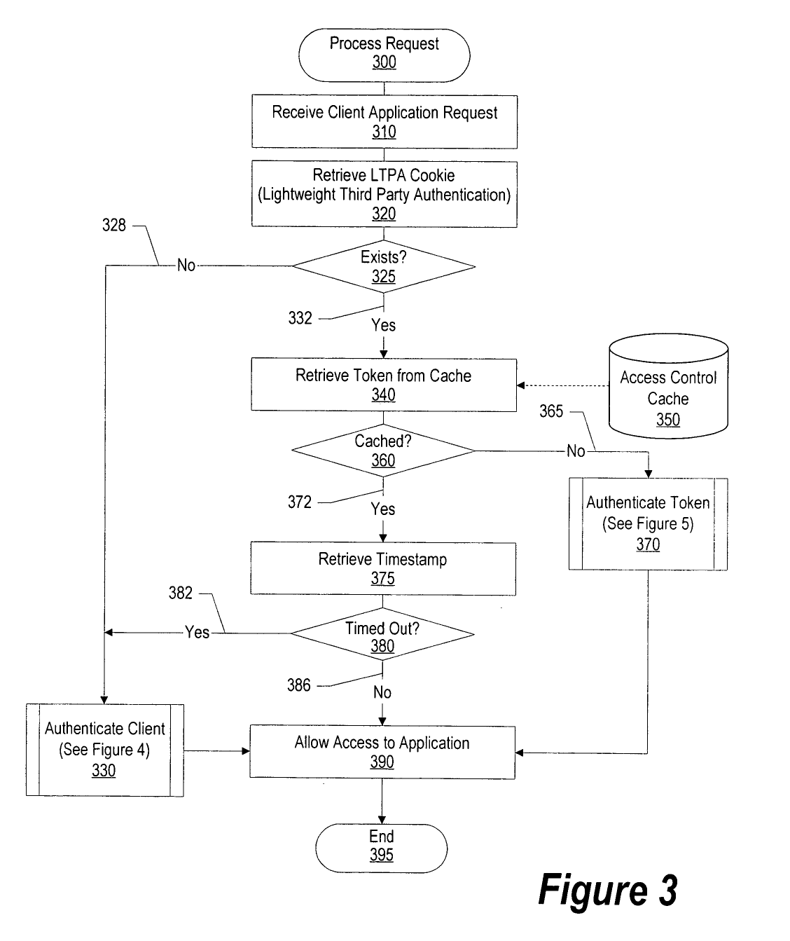

FIG. 3 is a flowchart showing steps taken by a server in processing a client's request. Processing commences at 300 whereupon, at step 310, the server receives a client application request indicating that the client is requesting access to a particular application or resource hosted by the server.

At step 320, the authentication cookie is retrieved from the client computer system. In one embodiment, the authentication cookie contains a Lightweight Third Party Authentication (LTPA) token. In another embodiment, the authentication cookie contains a Single Sign-on token which is not necessarily the same as the LTPA authentication token.

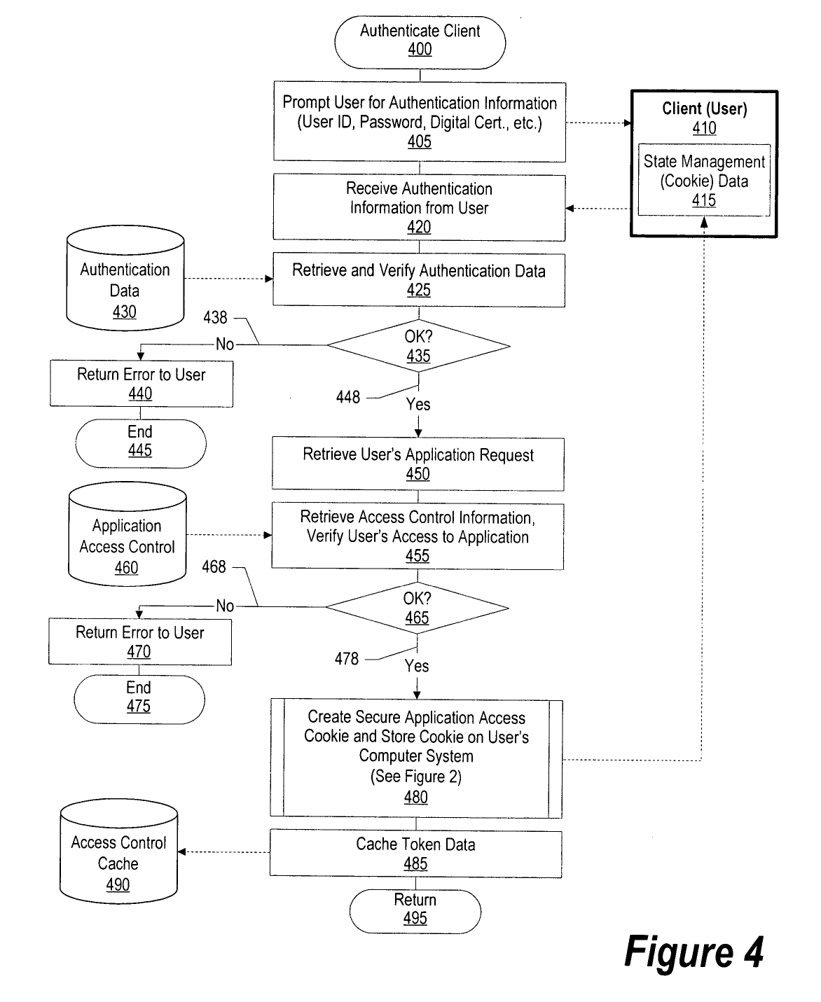

A determination is made as to whether the authentication cookie currently exists on the client computer system (decision 325). If the authentication cookie does not exist, decision 325 branches to “no” branch 328 whereupon the client is authenticated (predefined process 330, see FIG. 4 and corresponding text for processing details). At step 390, upon being authenticated, the client is allowed access to the requested application and request processing ends at 395.

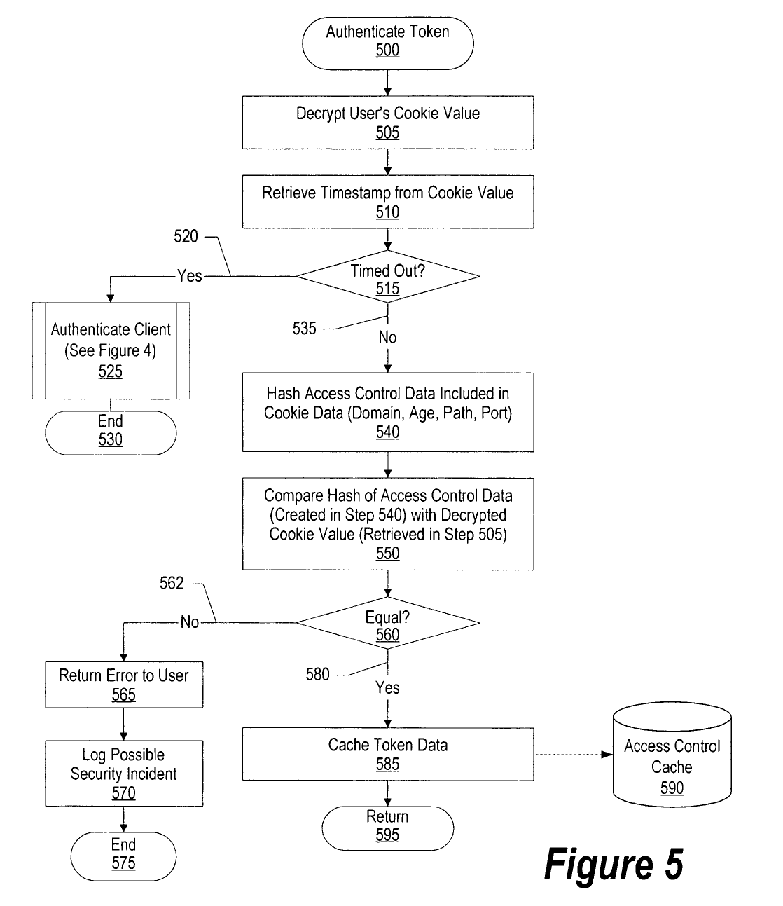

Returning to decision 325, if the access cookie does exist on the client computer system, decision 325 branches to “yes” branch 332 whereupon, at step 340, the authenticated user's security context corresponding to the access cookie is retrieved from access control cache 350. In one embodiment, access control cache is accessible by a group of servers so that any server included in the group can retrieve the token. Access control cache 350 can be stored on nonvolatile storage, such as a hard drive or nonvolatile memory, or can be stored on volatile storage, such as random access memory (RAM). In another embodiment, each of the servers within the Web site domain maintains its own cache. If the user, through the course of using the Web site, is moved from one server to another (i.e., because of server availability, load balancing, resource availability, etc.) then, if the new server does not have the token in its cache, the token included in the cookie is authenticated (see FIG. 5 and corresponding text for details). In another embodiment, the new server may use the information in the cookie, and the token within the cookie, to determine the set of servers that have the authenticated user's security context information. In this embodiment, the new server may retrieve the security context via a security context distribution mechanism.

A determination is made as to whether the token matching the access cookie has been cached in the access control cache (decision 360). In one embodiment, the token is the value set in the cookie (see value 270 in FIG. 2 for an example) . If the token has not been cached, decision 360 branches to “no” branch 365 whereupon the token is authenticated (predefined process 370, see FIG. 5 and corresponding text for processing details). At step 390, upon being authenticated, the client is allowed access to the requested application and request processing ends at 395.

Returning to decision 360, if the token is found in the access control cache, decision 360 branches to “yes” branch 372 whereupon, at step 375, the timestamp is retrieved from the cookie. A determination is made, at decision 380, as to whether the cookie data is stale (i.e., timed-out). The amount of time it takes for the cookie data to become stale is configurable by the Web site. Operators of Web sites that manage highly sensitive data may decide to configure access cookies with shorter life spans than operators of Web sites with less sensitive data. If the access cookie has timed out, decision 380 branches to “yes” branch 382 whereupon the client is authenticated (predefined process 330, see FIG. 4 and corresponding text for processing details). At step 390, upon being authenticated, the client is allowed access to the requested application and request processing ends at 395.

Returning to decision 380, if the access cookie has not timed out, decision 380 branches to “no” branch 386 whereupon, at step 390, the client computer is allowed access to the application without further authentication and request processing ends at 395.

FIG. 4 is a flowchart showing steps taken by a server in authenticating a client to the server. Processing commences at 400 whereupon, at step 405, the user is prompted for authentication information, such as a user identifier/password, digital certificate, biometric data, and the like. Client computer system 410 receives the prompt and replies with the requested authentication information.

At step 420, the server receives the authentication information supplied by the user of the client computer system. At step 425, the server validates the authentication information against a user registry or using an authentication service, such as Kerberos. Authentication data 430 is stored on a nonvolatile storage device, such as nonvolatile RAM or a hard disk. The authenticated user's identity and other security attributes are stored in a cache in memory for faster retrieval. Some security attributes, such as the authentication strength, determined during the authentication process, are preserved because it may be used later on in access control decisions. In one embodiment, the authentication data is loaded into a cache or RAM for faster retrieval.

A determination is made as to whether the authentication information supplied by the user matches the authentication data stored in user registry or in the authentication service (decision 435). If the user-supplied authentication information does not match the authentication data stored at the server, decision 435 branches to “no” branch 438 whereupon, at step 440, an error is returned to the user and processing ends at 445.

On the other hand, if the user-supplied authentication information matches the authentication data stored at the server, decision 435 branches to “yes” branch 448 whereupon, at step 450, the user retrieves the user's application request (i.e., the software application or resource on the server that the user is requesting to access). At step 455, application access control data 460 is retrieved and the user's access request is verified. Application access control data 460 is stored on a nonvolatile storage device, such as nonvolatile RAM or a hard disk. In one embodiment, the application access control data is loaded into a cache or RAM for faster retrieval.

The application access control data indicates, for example, whether the user has access to the order entry software application, the financial application, the billing application, or any number of software applications hosted by the server. A particular user may have access to one software application or may have access to multiple software applications. For example, an order entry clerk may only have access to the order entry application, while a manager may have access to the billing and financials applications. Special users, such as system administrators, may have access to all applications in order to maintain the various applications being hosted by the server.

A determination is made as to whether the user has been granted access to the application or resource that is being requested (decision 465). If the user has not been granted access to the requested application or resource, decision 465 branches to “no” branch 468 whereupon, at step 470, an error is returned to the user and processing ends at 475. On the other hand, if the user has been granted access to the requested application or resource, decision 478 branches to “yes” branch 478.

Following “yes” branch 478, the server first creates a secure application access cookie and stores it on the client computer system (predefined process 480, see FIG. 2 and corresponding text for processing details). At step 485, the application access token is stored in access control cache 490. The authenticated user's security context information is stored in access control cache indexed by the single sign-on token that is in the secure application access cookie. In one embodiment, the token is the value that is stored in the application access cookie (i.e., the value stored in FIG. 2, cookie value 270). After the cookie has been created and stored and the access token has been cached, processing returns to the calling routine (i.e., FIG. 3) at 495.

FIG. 5 is a flowchart showing steps taken by a server in authenticating a token. This processing is called when a server does not have a token corresponding to a client's cookie data cached in its cache area (see FIG. 3, predefined process 370 for details on when the processing shown in FIG. 5 is called).

Processing commences at 500 whereupon, at step 505 the value of the user's cookie (see FIG. 2, value 270 and corresponding text for more details regarding the user's cookie value) is decrypted using an encryption key maintained by the server. In one embodiment, a Public Key-Private Key pair of encryption keys is used for encrypting the cookie value (in FIG. 2, i.e., using the server's public key for encrypting) and decrypting the cookie value in step 505 (i.e., using the server's private key value for decrypting). In another embodiment, a single key is used for both encrypting and decrypting the value. In one embodiment, the hash value was digitally signed by the server as well as being encrypted. In this embodiment, the hash value is decrypted twice (i.e., once to decrypt the encryption performed at step 260 in FIG. 2 and once to decrypt the digital signature placed on the hash value at step 240 in FIG. 2). In one embodiment using a Public Key-Private Key pair, the digital signature was placed on the hash value by encrypting the hash value with the server's private key so that, in step 505, the digital signature is authenticated by decrypting the hash value using the server's public key.

After the cookie value has been decrypted, the timestamp is retrieved from the decrypted cookie value (step 510). A determination is made, at decision 515, as to whether the cookie data is stale (i.e., timed-out) based on the timestamp. If the access cookie has timed out, decision 515 branches to “yes” branch 520 whereupon the client is authenticated (predefined process 5250, see

FIG. 4 and corresponding text for processing details) and token authentication processing ends at 530.

Returning to decision 515, if the cookie has not timed out, decision 515 branches to “no” branch 535 in order to further interrogate the token data. At step 540, the access control data included in the cookie data is hashed using the same hashing algorithm used to hash the data in FIG. 2. The same access control data fields are used in step 540 as were used in FIG. 2 (step 240). In one embodiment, these fields include the Domain, Max-Age, Path, and Port fields.

At step 550, the hash value created in step 540 is compared with the hash value that was retrieved from the cookie and decrypted in step 505. A determination is made as to whether the hash values are the same (decision 560). If the hash values are not the same, decision 560 branches to “no” branch 562 whereupon, at step 565, an error is returned to the user and at step 570 a log record is written indicating a possible security incident (i.e., the client may have attempted to hack the cookie data to gain unauthorized access). The log record can be used to follow up with the end user to determine whether the user was attempting to hack the access control data and appropriate disciplinary actions can be taken. Token authentication processing thereafter ends at 575.

Returning to decision 560, if the hash values are equal, decision 560 branches to “yes” branch 580 whereupon, at step 585, the token data (i.e., the value stored in the cookie data) is cached by writing the data to access control cache 590. In one embodiment, the data contained in the single sign-on token may put further restriction on what resources may be accessed by the authenticated user. For example, the SSO token may contain data to restrict an authenticated user to access one particular application. In another embodiment, the data in the single sign-on token may indicate from which service to retrive privileged security attributes of the authenticated user. Processing thereafter returns to the calling routine (i.e., FIG. 3) at 595.

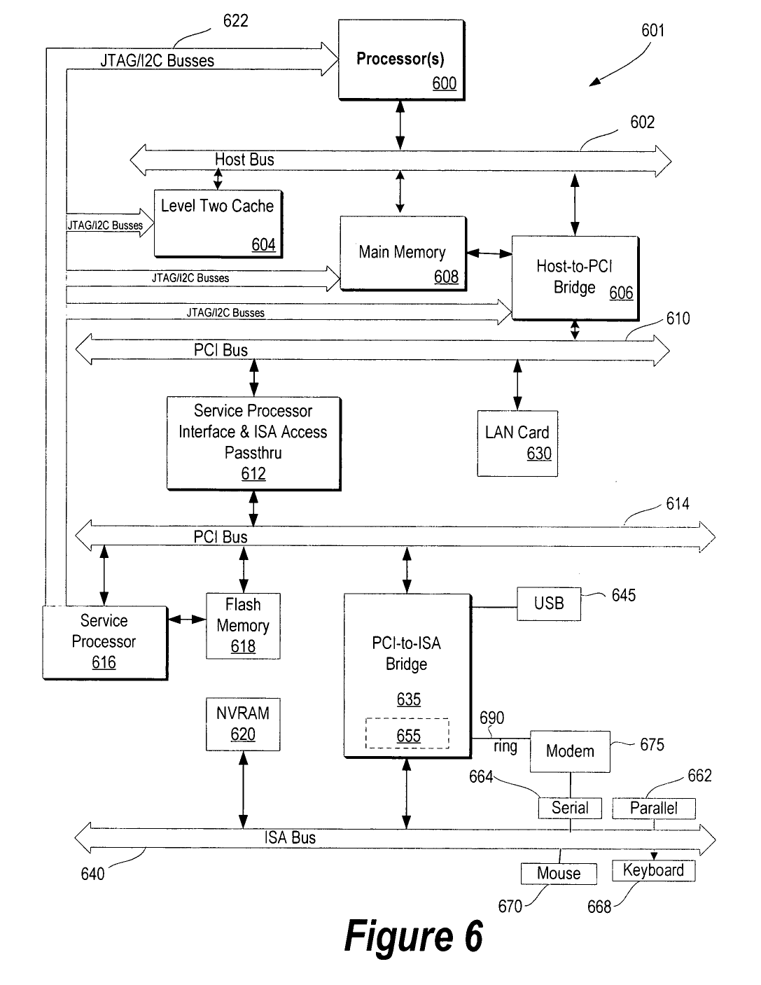

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608. is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

While the computer system described in FIG. 6 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method of handling client state information, said method comprising:
receiving, at a first computer system, a first request from a second computer system, wherein the first request is received over a computer network;
identifying access control data pertaining to the second computer system;
creating an encrypted value based upon the access control data; and
storing, on the second computer system, a state management data structure that includes an access control identifier and the encrypted value.

2. The method of claim 1 further comprising:
authenticating a user of the second computer system; and
caching, on the first computer system, security attributes of the authenticated user that are too sensitive to be included in the state management data structure, wherein the cached security attributes are indexed by the encrypted value and wherein cached security attributes are adapted to re-establish a security context of the authenticated user.

3. The method of claim 1 wherein the access control identifier is selected from the group consisting of the access control data and a unique identifier used by the first computer system to map to the access control data stored on an authentication server.

4. The method of claim 1 wherein at least one field included in the access control data is selected from the group consisting of: a domain, a maximum age, a path, a port, an authentication strength value, an authenticating server identifier, and an access control privilege identifier.

5. The method of claim 1 wherein the creation of the encrypted value further comprises:
hashing the access control data using a hashing algorithm, the hashing resulting in a hash value; and
encrypting the hash value.

6. The method of claim 1 further comprising:
storing the encrypted value at the first computer system in response to receiving the first request;
receiving a second request from the second computer system;
retrieving the state management data structure from the second computer system, the retrieving performed in conjunction with the reception of the second request; and
comparing the encrypted value included in the retrieved state management data structure with the encrypted value stored at the first computer system.

7. The method of claim 6 further comprising:
re-establishing an authenticated user's security context by using the encrypted value as a key to retrieve the access control data cached on the first computer system.

8. The method of claim 1 further comprising:
authenticating a user of the second computer system, wherein the identifying, creating, and storing are performed in response to successfully authenticating the user.

9. The method of claim 8 further comprising:
determining that the third computer system does not have access to the authentication data;
retrieving the authentication data from an authentication server in response to the determination; and
storing the retrieved authentication data on a cache associated with the third computer system.

10. The method of claim 1 further comprising:
receiving, at the first computer system, a second request from the second computer system;
retrieving the state management data structure from the second computer system, the retrieving performed in conjunction with the reception of the second request;
determining that the retrieved state management data structure is stale based on a timestamp included in the state management data structure; and
authenticating a user of the second computer system in response to the determination.

11. An first information handling system comprising:
one or more processors;
a memory accessible by the processors;
a network interface connecting the information handling system to a computer network;
a tool for handling client state information, the tool including software effective to:
receive, at the first information handling system, a first request from a second information handling system, wherein the first request is received over a computer network;
identify access control data pertaining to the second information handling system;
create an encrypted value based upon the access control data; and
store, on the second information handling system, a state management data structure that includes an access control identifier and the encrypted value.

12. The information handling system of claim 11 further comprising software effective to:
authenticate a user of the second information handling system; and
cache, on the first information handling system, security attributes of the authenticated user that are too sensitive to be included in the state management data structure, wherein the cached security attributes are indexed by the encrypted value and wherein cached security attributes are adapted to re-establish a security context of the authenticated user.

13. The information handling system of claim 11 wherein the access control identifier is selected from the group consisting of the access control data and a unique identifier used by the first information handling system to map to the access control data stored on an authentication server.

14. The information handling system of claim 11 wherein at least one field included in the access control data is selected from the group consisting of: a domain, a maximum age, a path, a port, an authentication strength value, an authenticating server identifier, and an access control privilege identifier.

15. The information handling system of claim 11 wherein the creation of the encrypted value further comprises software effective to:
hash the access control data using a hashing algorithm, the hashing resulting in a hash value; and
encrypt the hash value.

16. The information handling system of claim 11 further comprising software effective to:
store the encrypted value at the first information handling system in response to receiving the first request;
receive a second request from the second information handling system;
retrieve the state management data structure from the second information handling system, the retrieval performed in conjunction with the reception of the second request; and
compare the encrypted value included in the retrieved state management data structure with the encrypted value stored at the first information handling system.

17. The information handling system of claim 16 further comprising software effective to:
re-establish an authenticated user's security context by using the encrypted value as a key to retrieve the access control data cached on the first information handling system.

18. The information handling system of claim 11 further comprising software effective to:
authenticate a user of the second information handling system, wherein the identifying, creating, and storing are performed in response to successfully authenticating the user.

19. The information handling system of claim 18 further comprising software effective to:
determine that a third information handling system does not have access to the authentication data;
retrieve the authentication data from an authentication server in response to the determination; and
store the retrieved authentication data on a cache associated with the third information handling system.

20. The information handling system of claim 11 further comprising software effective to:
receive, at the first information handling system, a second request from the second information handling system;
retrieve the state management data structure from the second information handling system, the retrieving performed in conjunction with the reception of the second request;
determine that the retrieved state management data structure is stale based on a timestamp included in the state management data structure; and
authenticate a user of the second information handling system in response to the determination.

21. A computer program product stored on a computer operable media for handling client state data, said computer program product comprising:
means for receiving, at a first computer system, a first request from a second computer system, wherein the first request is received over a computer network;
means for identifying access control data pertaining to the second computer system;
means for creating an encrypted value based upon the access control data; and
means for storing, on the second computer system, a state management data structure that includes an access control identifier and the encrypted value.

22. The computer program product of claim 21 further comprising:
means for authenticating a user of the second computer system; and
means for caching, on the first computer system, security attributes of the authenticated user that are too sensitive to be included in the state management data structure, wherein the cached security attributes are indexed by the encrypted value and wherein cached security attributes are adapted to re-establish a security context of the authenticated user.

23. The computer program product of claim 21 wherein the access control identifier is selected from the group consisting of the access control data and a unique identifier used by the first computer system to map to the access control data stored on an authentication server.

24. The computer program product of claim 21 wherein at least one field included in the access control data is selected from the group consisting of: a domain, a maximum age, a path, a port, an authentication strength value, an authenticating server identifier, and an access control privilege identifier.

25. The computer program product of claim 21 wherein the means for creating the encrypted value further comprises:
means for hashing the access control data using a hashing algorithm, the hashing resulting in a hash value; and
means for encrypting the hash value.

26. The computer program product of claim 21 further comprising:
means for storing the encrypted value at the first computer system in response to receiving the first request;
means for receiving a second request from the second computer system;
means for retrieving the state management data structure from the second computer system, the means for retrieving performed in conjunction with the reception of the second request; and
means for comparing the encrypted value included in the retrieved state management data structure with the encrypted value stored at the first computer system.

27. The computer program product of claim 26 further comprising:
means for re-establishing an authenticated user's security context by using the encrypted value as a key to retrieve the access control data cached on the first computer system.

28. The computer program product of claim 21 further comprising:
means for authenticating a user of the second computer system, wherein the identifying, creating, and storing are performed in response to successfully authenticating the user.

29. The computer program product of claim 28 further comprising:
means for determining that the third computer system does not have access to the authentication data;
means for retrieving the authentication data from an authentication server in response to the determination; and
means for storing the retrieved authentication data on a cache associated with the third computer system.

30. The computer program product of claim 21 further comprising:
means for receiving, at the first computer system, a second request from the second computer system;
means for retrieving the state management data structure from the second computer system, the means for retrieving performed in conjunction with the reception of the second request;
means for determining that the retrieved state management data structure is stale based on a timestamp included in the state management data structure; and
means for authenticating a user of the second computer system in response to the determination.
